(19) United States
(12) Patent Application Publication
(10) Pub. No.: US 2024/0297524 A1
(43) Pub. Date: Sep. 5, 2024

(54) ENERGY CONVERSION AND MANAGEMENT SYSTEM

(71) Applicant: STRENGTH MASTER FITNESS TECH CO., LTD., CHANGHUA COUNTY (TW)

(72) Inventor: SHU YAO WU, CHANGHUA COUNTY (TW)

(21) Appl. No.: 18/178,030

(22) Filed: Mar. 3, 2023

(51) Int. Cl. H02J 7/14; A63B 24/00; H02J 7/00

(52) U.S. Cl. CPC H02J 7/1415; A63B 24/0062; A63B 24/0087; H02J 7/00032; B60L 53/57

(57) ABSTRACT

An energy conversion and management system has an exercise device and an information management platform. The exercise device includes a power generation device. The power generation device is electrically connected to an energy storage device. The energy storage device includes at least one connection port. The energy storage device is electrically connected to an electricity-receiving device via the connection port for supplying electric energy. The information management platform is configured to capture and record kinetic energy data and electric energy data of the exercise device and to manage history information that the exercise device exchanges the electric energy to the electricity-receiving device via the energy storage device, so as to continuously track where the electric energy supplied by the energy storage device goes, thereby achieving the effect of comprehensive supervision.

### FIELD OF THE INVENTION

The present invention relates to an energy management system, and more particularly to an energy conversion and management system.

### BACKGROUND OF THE INVENTION

For general exercise and fitness machines, such as a flywheel exercise bike, the resistance to rotation when the user steps on the exercise machine can be adjusted through a resistance setting device, such that the user can adjust a desired exercise intensity.

In order not to waste the kinetic energy generated by doing exercise, a conventional exercise machine may be equipped with an energy storage device for converting the kinetic energy generated by the user's exercise into electric energy to be stored, so as to supply power to other equipment for operation.

However, the conventional exercise machine lacks the function of exchange management when converting the stored electric power to other uses. The electricity may be converted into a trading subject and the user's exercise data corresponding to electricity value have not been supervised effectively, so the conventional exercise machine needs to be improved.

### SUMMARY OF THE INVENTION

The primary object of the present invention is to provide an energy conversion and management system, which has an information management platform for recording kinetic energy data and electric energy data of an exercise device, thereby managing the exchange history information of the exercise device after kinetic energy is converted into electric energy and having the function of comprehensive supervision.

In order to achieve the foregoing object, the energy conversion and management system provided by the present invention comprises at least one exercise device and an information management platform. The exercise device includes at least one power generation device. The power generation device is electrically connected to an energy storage device. The energy storage device includes at least one connection port. The energy storage device is electrically connected to an electricity-receiving device via the connection port for supplying electric energy. The information management platform is in communication with the exercise device and the electricity-receiving device. The information management platform is configured to capture and record kinetic energy data and electric energy data of the exercise device and to manage history information that the exercise device exchanges the electric energy to the electricity-receiving device via the energy storage device. When a user operates the exercise device, the information management platform records the kinetic energy data generated by the user and the electric energy data converted from the kinetic energy data. The history information includes the usage amount of the electric energy data, the remaining amount of the electric energy data of the energy storage device, and the electricity-receiving device to which the electric energy data is transmitted.

Preferably, the exercise device further includes a detection element for detecting the user's exercise information.

Preferably, the power generation device is a structure that generates power via rotation and acquires the corresponding electric energy via the rotation speed and impedance value of the exercise device.

Preferably, the energy storage device is internally/externally connected to the exercise device. The energy storage device is electrically connected to the electricity-receiving device via the connection port and supplies the electric energy to the electricity-receiving device, or the connection port is connected to a transfer port to transfer the electric energy to the electricity-receiving device.

Preferably, the electricity-receiving device is one of a mobile power supply, an energy storage cabinet and an electric car. When the electricity-receiving device is disconnected from the energy storage device, the electricity-receiving device serves as a power supply.

Preferably, the exercise device is provided with a pre-downloaded program or APP and connected to the information management platform, so as to acquire the kinetic energy data and the electric energy data of the exercise device.

Preferably, the electricity-receiving device is provided with a pre-downloaded program or APP and connected to the information management platform, so as to acquire the information where the electric energy of the energy storage device goes.

Preferably, the information management platform further has a transaction point counting unit for converting the electric energy into transaction points to be stored in the transaction point counting unit. When the energy storage device and the electricity-receiving device consume the electric energy, the transaction points in the transaction point counting unit are deducted.

### BRIEF DESCRIPTION OF THE DRAWINGS

FIG. 1 is a block diagram of the present invention;

FIG. 2 is a perspective view of the exercise device and the electricity-receiving device of the present invention;

FIG. 3 is a flowchart of the steps of the present invention;

FIG. 4 is another flowchart of the steps of the present invention;

FIG. 5 is a block diagram of the present invention provided with the transfer port; and

FIG. 6 is a block diagram of the present invention, wherein the energy storage device is installed in the electricity-receiving device.

### DETAILED DESCRIPTION OF THE PREFERRED EMBODIMENTS

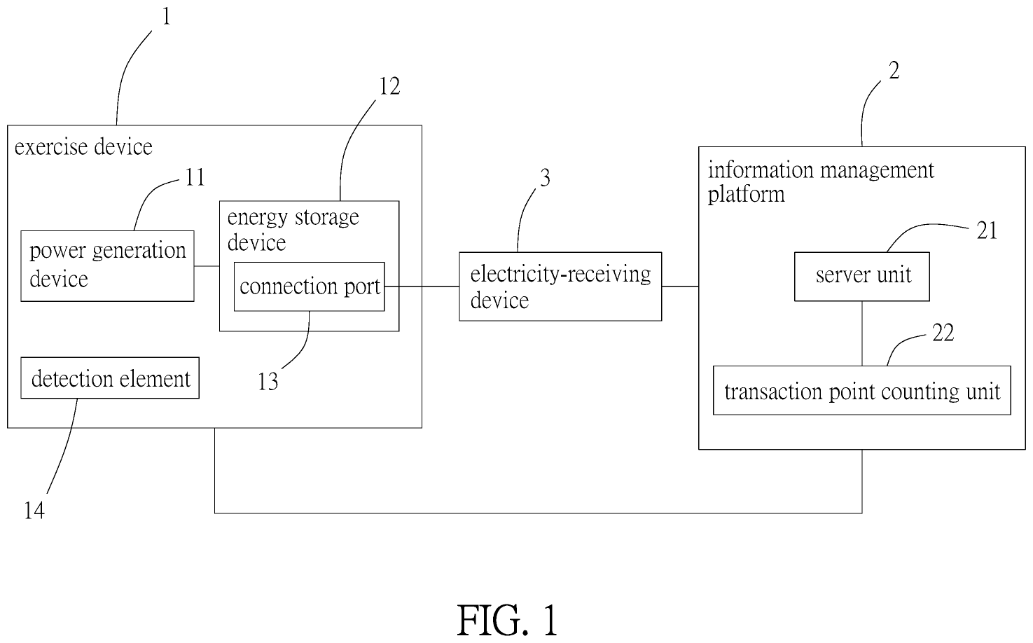

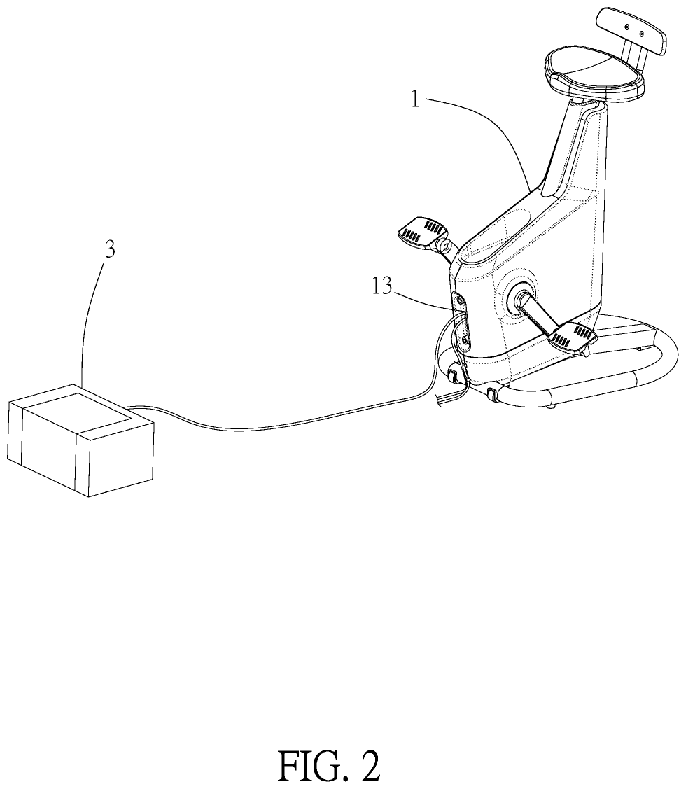

Referring to FIG. 1 through FIG. 6, an energy conversion and management system provided by the present invention comprises at least one exercise device 1 and an information management platform 2.

The exercise device 1 includes at least one power generation device 11. The power generation device 11 is electrically connected to an energy storage device 12. The energy storage device 12 includes at least one connection port 13. The exercise device 1 further includes a detection element 14 for detecting the user's exercise information.

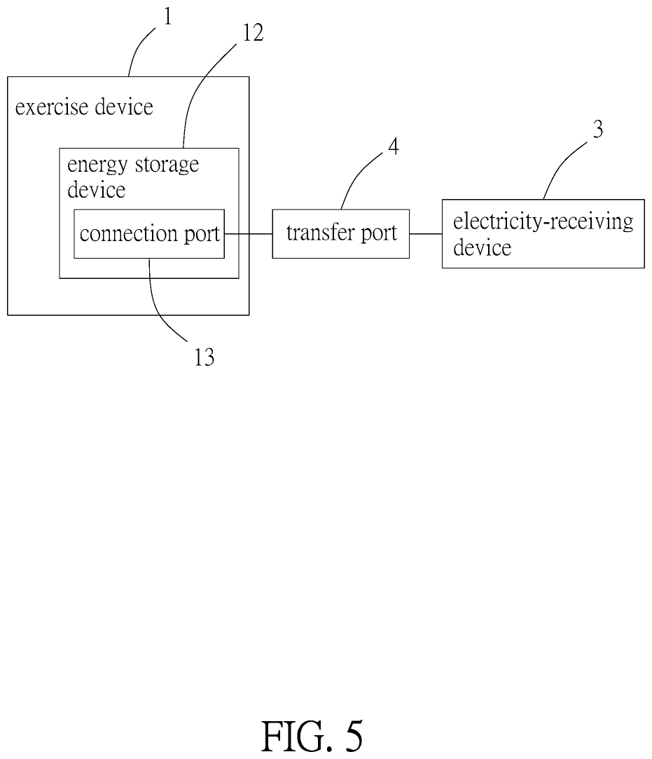

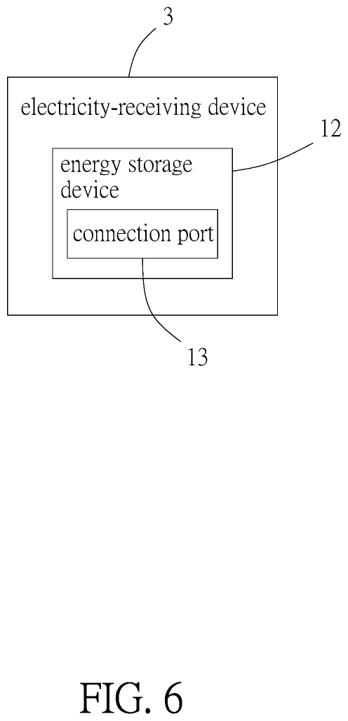

In this embodiment, the exercise device 1 is a flywheel exercise bike. The power generation device 11 is a structure that generates power via rotation. The rotational kinetic energy of the exercise device 1 is converted into corresponding electric energy by setting the rotation speed and impedance value of the exercise device 1. The energy storage device 12 is internally/externally connected to the exercise device 1 for storing electric energy in the energy storage device 12. Furthermore, the energy storage device 12 is electrically connected to an electricity-receiving device 3 via the connection port 13, so as to supply the electric energy to the electricity-receiving device 3, or the connection port 13 is connected to a transfer port 4 to transfer the electric energy to the electricity-receiving device 3 (as shown in FIG. 5). The electricity-receiving device 3 may be a mobile power supply, an energy storage cabinet or an electric car. The electricity-receiving device 3 acquires the electric energy from the energy storage device 12 to keep its operation. The energy storage device 12 may be detachably connected to the exercise device 1. When the energy storage device 12 is separated from the exercise device 1, the energy storage device 12 is directly disposed on and connected to the electricity-receiving device 3 (as shown in FIG. 6) to supply the electric energy to the electricity-receiving device 3. The electricity-receiving device 3 may be disconnected from the energy storage device 12, so that the electricity-receiving device 3 can supply the electric energy to other objects. In addition, the energy storage device 12 may directly supply the electric energy to other objects.

The information management platform 2 has a server unit 21. The information management platform 2 is in communication with the exercise device 1 and the electricity-receiving device 3 to record kinetic energy data (the user's exercise information) and electric energy data (power generation data) of the exercise device 1 that are captured by the detection element 14 in the server unit 21, and to manage history information that the exercise device 1 exchanges the electric energy to the electricity-receiving device 3 via the energy storage device 12. The history information includes the usage amount of the electric energy data, the remaining amount of the electric energy data of the energy storage device 12 and the electricity-receiving device 3 to which the electric energy data is transmitted. In this embodiment, when a user operates the exercise device 1, the information management platform 2 records the kinetic energy data generated by the user and the electric energy data converted from the kinetic energy data. The exercise device 1 is provided with a pre-downloaded program or APP, and is connected to the information management platform 2, so that the user can acquire the kinetic energy data and the electric energy data of the exercise device 1 from the server unit 21 via the exercise device 1. The electricity-receiving device 3 is provided with a pre-downloaded program or APP, and is connected to the information management platform 2, so that the user can acquire the information where the electric energy exchanged from the energy storage device 12 goes via the electricity-receiving device 3, such as the charging time and charging amount of an external device (the electricity-receiving device 3). Furthermore, the user may connect the exercise device 1 and the electricity-receiving device 3 in a wireless or wired manner via an electronic device (such as a mobile phone or a tablet), and enter an account password to log in the information management platform 2 to acquire the above-mentioned data and the information where the electric energy goes.

In addition, the information management platform 2 further has a transaction point counting unit 22. The information management platform 2 converts the electric energy generated by the user's exercise into transaction points to be stored in the transaction point counting unit 22. When the energy storage device 12 and the electricity-receiving device 3 consume or supply the electric energy, the transaction points corresponding to the power consumption or power supply in the transaction point counting unit 22 are deducted. The user may log in the information management platform 2 via the electronic device to check the remaining transaction points.

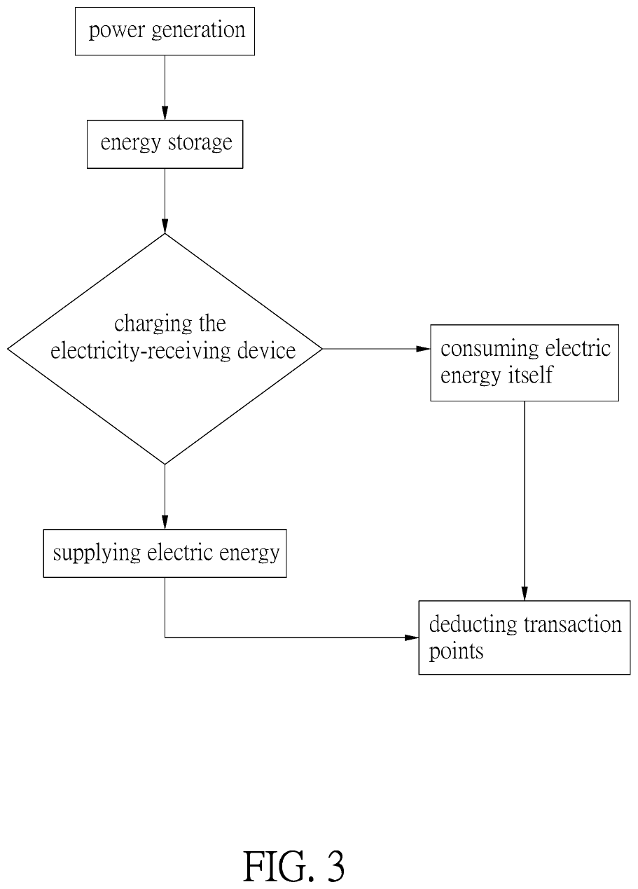

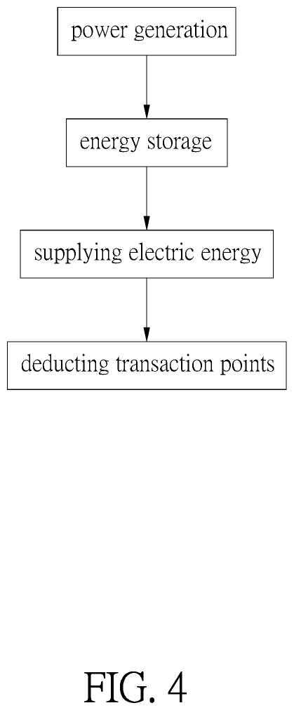

As it can be seen from the above description of the present invention that, referring to FIG. 3 and FIG. 4, after the user logs in the information management platform 2, he/she does exercise on the exercise device 1, and the kinetic energy is converted into electric energy via the power generation device 11 to be stored in the energy storage device 12. The information management platform 2 converts the electric energy generated by the user's exercise into transaction points. The energy storage device 12 supplies the electric energy to the electricity-receiving device 3 or other objects. As shown in FIG. 3, when the energy storage device 12 supplies the electric energy to the electricity-receiving device 3 and the electricity-receiving device 3 consumes the electric energy itself to maintain its operation or supplies the electric energy to other objects, only the transaction points corresponding to the power supply amount will be deducted, without other costs. As shown in FIG. 4, the energy storage device 12 may directly supply the electric energy to other objects. Similarly, only the transaction points corresponding to the power supply amount will be deducted, without other costs. The information management platform 2 records the kinetic energy data and the electric energy data of the exercise device 1, so as to achieve the purpose of integrating various data. By managing the history information of the electric energy exchanged by the exercise device 1 via the energy storage device 12, the information where the electric energy supplied by the energy storage device 12 goes can be continuously tracked, so as to achieve effective supervision and control.

What is claimed is:

1. An energy conversion and management system, comprising:
at least one exercise device, including at least one power generation device, the power generation device being electrically connected to an energy storage device, the energy storage device including at least one connection port, the energy storage device being electrically connected to an electricity-receiving device via the connection port for supplying electric energy;
an information management platform, being in communication with the exercise device and the electricity-receiving device, the information management platform being configured to capture and record kinetic energy data and electric energy data of the exercise device and manage history information that the exercise device exchanges the electric energy to the electricity-receiving device via the energy storage device; wherein when a user operates the exercise device, the information management platform records the kinetic energy data generated by the user and the electric energy data converted from the kinetic energy data, wherein the history information includes the usage amount of the electric energy data, the remaining amount of the electric energy data of the energy storage device, and the electricity-receiving device to which the electric energy data is transmitted.

2. The energy conversion and management system as claimed in claim 1, wherein the exercise device further includes a detection element for detecting the user's exercise information.

3. The energy conversion and management system as claimed in claim 1, wherein the power generation device is a structure that generates power via rotation and acquires the corresponding electric energy via the rotation speed and impedance value of the exercise device.

4. The energy conversion and management system as claimed in claim 1, wherein the energy storage device is internally/externally connected to the exercise device, the energy storage device is electrically connected to the electricity-receiving device via the connection port and supplies the electric energy to the electricity-receiving device, or the connection port is connected to a transfer port to transfer the electric energy to the electricity-receiving device.

5. The energy conversion and management system as claimed in claim 1, wherein the electricity-receiving device is one of a mobile power supply, an energy storage cabinet and an electric car, when the electricity-receiving device is disconnected from the energy storage device, the electricity-receiving device serves as a power supply.

6. The energy conversion and management system as claimed in claim 1, wherein the exercise device is provided with a pre-downloaded program or APP and connected to the information management platform, so as to acquire the kinetic energy data and the electric energy data of the exercise device.

7. The energy conversion and management system as claimed in claim 1, wherein the electricity-receiving device is provided with a pre-downloaded program or APP and connected to the information management platform, so as to acquire the information where the electric energy of the energy storage device goes.

8. The energy conversion and management system as claimed in claim 1, wherein the information management platform further has a transaction point counting unit for converting the electric energy into transaction points to be stored in the transaction point counting unit, when the energy storage device and the electricity-receiving device consume the electric energy, the transaction points in the transaction point counting unit are deducted.
